(19) United States
(12) Patent Application Publication
(10) Pub. No.: US 2014/0021307 A1
(43) Pub. Date: Jan. 23, 2014

(54) In-Line Cable Strain Relief Device

(71) Applicant: Duncan McLauchlan, Roswell, GA (US)

(72) Inventor: Duncan McLauchlan, Roswell, GA (US)

(73) Assignee: Compagnie Industrielle et Financiere D'Ingenierie "Ingenico", Neuilly-Sur-Seine (FR)

(21) Appl. No.: 13/552,551

(22) Filed: Jul. 18, 2012

(51) Int. Cl. H02G 3/02

(52) U.S. Cl. 248/56

(57) ABSTRACT

A cable strain relief device is provided, which includes a plate having at least two lateral notches. The lateral notches provide a gripping area for a cable to connect.

### CROSS-REFERENCE TO RELATED APPLICATIONS

None.

### STATEMENT REGARDING FEDERALLY SPONSORED RESEARCH OR DEVELOPMENT

None.

### THE NAMES OF PARTIES TO A JOINT RESEARCH AGREEMENT None.

### FIELD OF THE DISCLOSURE

The present disclosure relates to cable connections. More specifically, the disclosure relates to cable connections for electrical or electronic cables that employ a mating in-line connection with no integral strain relief. The proposed device can be used for preventing or mitigating accidental disconnection of the cables.

### BACKGROUND OF THE DISCLOSURE

When a user wishes to maintain a cable connection between two or more cables, few solutions are at his disposition. One of them consists in using adhesive, placed around the two cables to maintain connection. This solution has drawbacks. The first one is that adhesive has to be removed when cables have to be disconnected. A second drawback is that when the adhesive is of poor quality, this results in two dirty cables which have to be cleaned.

Another solution is the use of cable clamp systems. These solutions, however, also have problems. For Example, box type containment clamshells require custom dimensioned solutions for every individual connector type, cable type, situation and use case. They are ineffective if not accurately dimensioned for a particular solution.

Fixed cable clamp solutions require attachment to a stable surface. Some potential solutions require the use of tools to allow implementation. Some temporary solutions require the use of additional surfaces as a reference or fixing point.

Looping and or tying cables to provide strain relief or to mitigate disconnection is considered ugly, temporary and unprofessional by many professional installers and users.

Strain mitigation systems employing ties tend to require tools for installation.

Strain mitigation systems employing ties also tend to require tools for de-installation or movement.

Consequently, there is no simple, clean, tool free and professional rendering solution for maintaining two cables together.

### SUMMARY

An embodiment of the present disclosure relates to a cable strain relief device comprising a plate. The plate includes at least two lateral notches, said lateral notches providing a gripping area for a cable to connect.

In a particular embodiment, the at least two lateral notches are positioned along opposing side edges of the plate.

In a particular embodiment, the at least two lateral notches are nearly equally distributed on each side of said plate.

In a particular embodiment, at least one lateral notch of said at least two lateral notches comprises a retention area laterally offset from a side edge of the plate.

The retention area may be semicircular. For example, the retention area and has an outer retention arm along the side edge of the plate such that the retention area supports the cable on opposing inside and outside lateral sides of the cable.

In a particular embodiment, the at least two lateral notches are inclined at acute angles relative to a side edge of the plate. For example, the at least two lateral notches comprise a first set of lateral notches on a first side of the plate and a second set of lateral notches on a second, opposite side of the plate, wherein adjacent the lateral notches in the first set have opposite acute angles relative to the first side of the plate, and wherein adjacent the lateral notches in the second set have opposite acute angles relative to the second side of the plate.

In a particular embodiment, the at least two lateral notches comprise a first set of lateral notches on a first side of the plate and a second set of lateral notches on a second, opposite side of the plate, which are longitudinally offset from one another.

In a particular embodiment, the plate further includes at least two end notches on opposing ends of the plate.

In a particular embodiment, the plate comprises at least one recess for positioning a body of a cable to connect. For example, the plate comprises two recesses, one for each body of two cables to connect.

In a particular embodiment, the plate comprises an even number of lateral notches, equally distributed on each side of said plate and wherein said notches form an angle of 45° or minus 45° with an orthogonal reference formed by a respective side of said plate.

A further embodiment of the present disclosure is directed to a cable strain relief device comprising a plate including first and second opposing edges and first and second notches formed in the first and second opposing edges. The notches provide a gripping area for a cable to connect.

In a particular embodiment, at least one of the first and second notches comprises a retention area offset from the respective first or second edge of the plate. For example, the retention area is semicircular.

The retention area has an outer retention arm along the respective first or second edge of the plate such that the retention area supports the cable on opposing inside and outside sides of the cable.

In situations where cables and connectors can be pulled or moved, either accidentally or by virtue the nature of the installation or location, a non-limiting, exemplary embodiment of this device provides a solution that mitigates potential disruption to service or operation. Typical installation examples of environments where the device could potentially be used and of benefit include, but are not limited to; retail and wholesale environments, office environments, commercial environments, medical environments, audio and visual systems environments, domestic environments, mobile equipment environments, transit environments, music industry environments, and cinema industry environments.

### BRIEF DESCRIPTION OF THE DRAWINGS

FIG. 1 discloses an upper view of an embodiment of the disclosed device;

FIG. 2 discloses a lateral view of the embodiment of FIG. 1;

FIG. 3 discloses an isometric view of the embodiment of FIG. 1;

FIG. 4 discloses an upper view of second embodiment of the disclosed device;

FIG. 5 discloses an upper view of third embodiment of the disclosed device;

FIG. 6 discloses an upper view of fourth embodiment of the disclosed device;

FIG. 7 disclose a perspective view of the embodiment of FIG. 1 in which two cables are connected and wound onto the device.

### DETAILED DESCRIPTION OF ILLUSTRATIVE EMBODIMENTS

An illustrative embodiment of the present disclosure relates to a strain relief device in the form of a plate or rod, for example, which has flexible dimensions to suit the type of cable and connectors to which the device is intended for use with, dependent upon the use case in hand. The device includes a solid material, which can be deformable as a function of the use case. In a particular embodiment, the device is formed of a plastic material. In other embodiments, the device can be wood, metal, or any near rigid material, for example.

In a particular example, the plate is elongated, with first and second opposing side edges and first and second opposing ends. A plurality of lateral notches are formed along the first and second side edges. For example, the lateral notches oppose one another about a longitudinal axis of the plate and are offset from one another along the longitudinal axis. The lateral notches are positioned so that cables to connect can be inserted in these lateral notches alternately from one side edge to the other side edge. Thus, each cable can be wrapped around the device in a helical manner and maintained in that position (thanks to the side notches) with minimal risk that the cable can be extracted from the device accidentally.

The plate also includes, in its central part, a pair of opposing recesses, which are also offset from one another along the longitudinal axis. The recesses are used to allow the connection of cables. In a particular embodiment, the recesses are designed so that two different types of cables can be connected. This is for example the case of a cable with straight body and a cable with angled body. A straight body cable has electrical (e.g., male and female) connectors extending in a direction generally parallel to the cable itself, whereas an angled body cable has electrical connectors extending at an angle (e.g., right angle) to the cable.

When angle body cables have to be connected, a problem occurs since the angle which is formed between the connectors cannot be managed properly. For example, in the case of box type containment clamshells, the angles which are formed by the connectors often prevent proper use of this box. Unlike this box, the recesses allow introducing the connectors as a function of the form of the connector. In case of a straight body cable, the recesses can be used to keep the alignment of the cable. In the case of an angle body cable, the recesses can be used to receive the angled connector. Thus, the alignment of cable is preserved.

Thus, the device eliminates the dependency on use of specifically designed and dimensioned solutions. A significant feature lies in the flexibility of application in a wide variety of use cases.

Furthermore, the device is a reusable, flexible and adaptable strain relief solution intended for use with, but not exclusively restricted to mating in-line cable connections that could normally, without this device or a device with a similar effect, be accidentally disconnected by applying opposing pulling forces to the cable ends.

Thus, the device prevents or mitigates accidental disconnection of electrical cables and connection systems that employ an in-line connection with no integral strain relief.

The device prevents or mitigates disconnection of mating electrical connectors by providing fast and simple application of a solution for providing strain relief for use on electrical cables that use an in-line connection on which, without use of a retention system, the mating connectors could be separated by pulling on or straining the cables or connectors. The connectors can be for example AC power connectors, audio jack connectors, DIN connectors, USB connectors, etc.

Cable systems that would benefit include, but are not restricted to, those using interference or friction connections that have no integral strain relief mechanism.

The device is designed to prevent disconnection of mated in-line connectors by introducing a series of bends (or notches) that introduce friction against the cable sheath, which grips and restricts the cable components' movement and reduces the potential for cable movement or displacement. The principle is to prevent disconnection by reducing potential for cable movement.

The combination of this principle, applied to both ends of the in-line cables, provides a safeguard to help avoid the connectors' physical separation and subsequent electrical and mechanical disconnection. The device accommodates use of a wide variety of cable and connector styles. With dimensional adjustments to the design principle, additional use cases may be employed. With adjustments to the product's scale and materials used, additional use cases and environments may discover benefit.

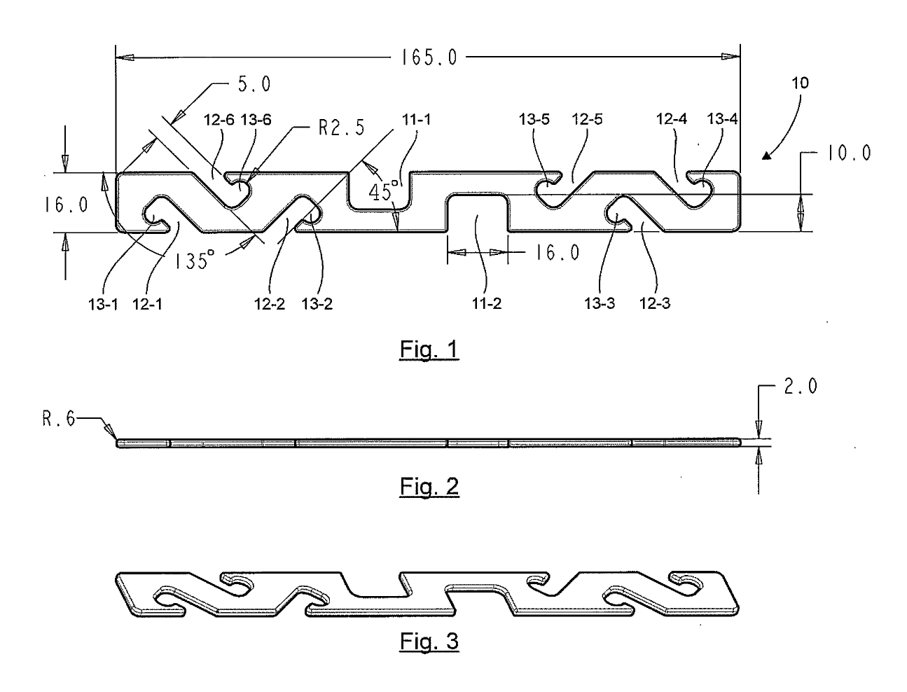

A particular embodiment of the device is shown in FIGS. 1 to 3. In this embodiment, the device is sized in order to connect “DIN” cables or male and female “jack” DC power cables. In this particular example, the device is in the form of a polycarbonate plate (10) measuring one hundred and sixty five millimeters long and sixteen millimeters wide and having a thickness of about two millimeters. The plate includes a first plurality of lateral notches (12-1, 12-2, 12-3) on a first end of the plate for securing a first cable and a second plurality of lateral notches (12-4, 12-5, 12-6) on a second end of the plate for securing a second cable. The device comprises two recesses or cut-outs (11-1, 11-2) of a parallelepiped shape in a central region of the plate (10) for receiving the ends of the respective cables when the cables are connected together in-line and secured to the plate (10).

These recesses, as explained below, allow connecting two cables having various connector bodies. In this embodiment, the plate has six lateral notches, three on each side (12-1, 12-2, 12-3, 12-4, 12-5, 12-6). In this embodiment, the lateral notches are alternately inclined at acute angles, such as forty-five degrees (45°) and minus forty-five degrees (−45° or +315°) relative to an orthogonal coordinate system formed by the sides and ends of the device (examples are shown for notch 12-2 and notch 12-6). The notches are formed as slots that angle inward toward a longitudinal axis of device 10 at the acute angles.

In the example shown in FIG. 1, the lateral notches comprise a first set of lateral notches on a first side of the plate and a second set of lateral notches on a second, opposite side of the plate, wherein adjacent the lateral notches in the first set have opposite acute angles relative to the first side of the plate, and wherein adjacent the lateral notches in the second set have opposite acute angles relative to the second side of the plate. The first set of lateral notches on the first side of the plate are longitudinally offset from the second set of lateral notches on a second, opposite side of the plate. These features facilitate cable insertion.

According to a particular characteristic, in this embodiment of the device, the inner end of each notch is completed by a retention area (13-1, 13-2, 13-3, 13-4, 13-5, 13-6) in which the cable is kept up. In the example shown, the retention area is semi-circular (the radius is 2.5 mm, for example) and has an outer retention arm (14-1, 14-2, 14-3, 14-4, 14-5, 14-6) such that the retention area supports the cable on two opposing lateral sides, an inside edge and an outside edge. In this example, the retention arms are generally hook-shaped. This feature ensures that the cable is not removed by mistake from the notches in which it is located. In other embodiments, the radius of the semi-circular retention area depends on the diameter of the cables to connect.

Thus, this embodiment of the device prevents or mitigates accidental separation of in-line electro mechanical connections that employ no integral strain relief system. The device also eliminates the need for component specific and dimensionally unique solutions to fit individual use cases, connector dimension variances, and cable dimensional variances. The device eliminates the need to employ fixed cable retention and strain relief systems. The device provides a flexible solution to allow fast, effective and simple application of strain relief mitigation for installers and users of cable systems, whether in a fixed or temporary situation or location.

Furthermore, unlike many other solutions, installation is readily reversible to allow removal and re-use for component replacement or movement activities. The device also eliminates the need for the use of tools in providing the above solutions, allowing successful use by an unaware user with zero preparation or aid. The device also eliminates any dependency on attachment to any additional surface.

In the described embodiment, the device is designed to be used with DC/DC in-line connectors and Mini-DIN in-line interface connectors to help prevent accidental disconnection of their mating halves.

This helps avoid situations where, in the event that the in-line cables are pulled or strained, the mating connectors may separate from each other. If this happens, connection to the connected equipment is lost, causing it to shut down.

Depending on the products provided, the connectors may differ in form. Examples include the following:
Some power supplies feature a straight body connector.
Some power supplies feature a right angled body connector.
Both of the above types connect to a mating in-line connector on the interface cable provided.
Some connections use a male and female in-line mini DIN 9 PIN interface and power interconnection.

FIGS. 4 to 6 disclose an upper view of other embodiments of the device. The same numbering logic has been kept for these embodiments, so that it is not necessary to comment them more. A difference between embodiments of FIGS. 4 to 6 between the embodiment of FIG. 1 is the presence of notches on all the sides of the device. In the first embodiment, only left and right side edges of the device comprise notches. In the embodiments of FIGS. 4 to 6, notches are also present in the upper and the lower side edges. Another difference from the embodiment shown in FIG. 1 is that the embodiments shown in FIGS. 4-6 do not include the central recesses (11-1 and 11-2). Furthermore, the size and the form of the notches and of the retention zones can also be different in view of the size and diameter of the cables to which the device is intended to be used.

More specifically, FIG. 4 discloses a simple embodiment in which two notches (12-1, 12-2) and two retention areas (13-1, 13-2) are included at opposite ends of the device 10. In this embodiment, the retention areas are perpendicular to the notches.

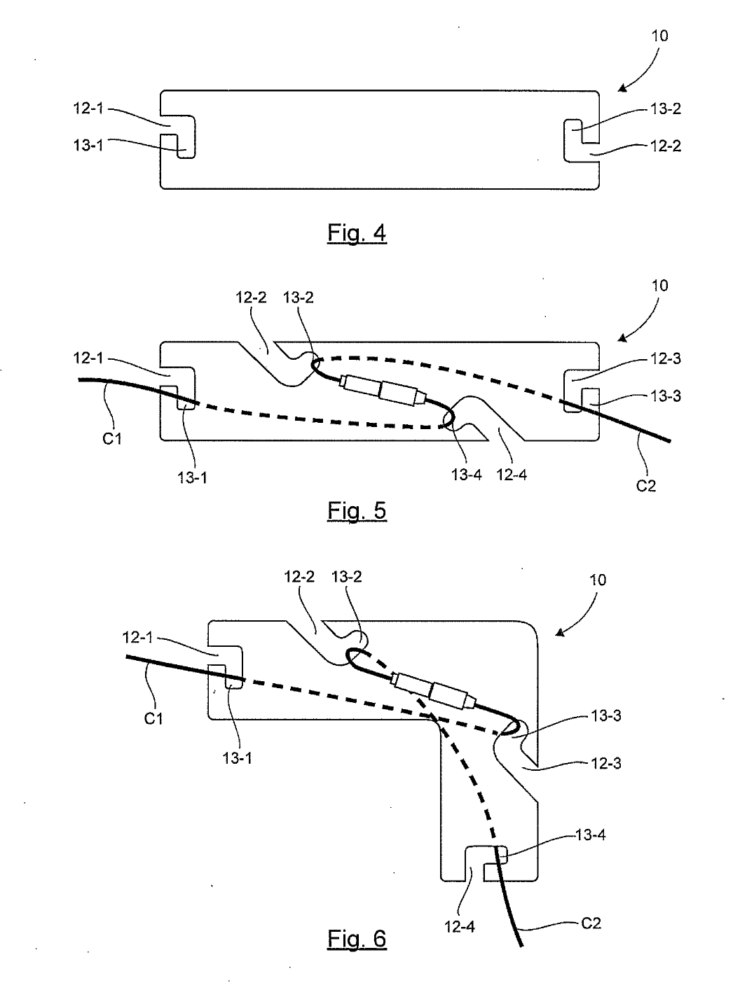

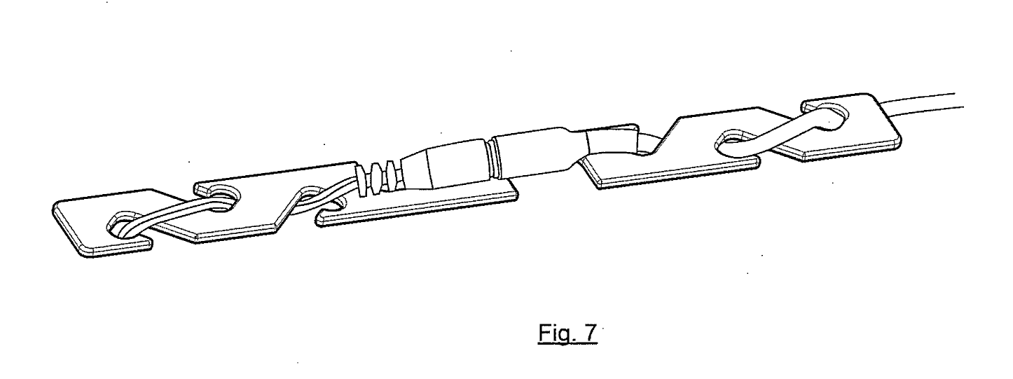

FIG. 5 discloses another embodiment of the device 10 in which two lateral notches have been added. In this embodiment, device 10 includes two notches (12-1, 12-3) and two retention areas (13-1, 13-3) at opposite ends of the device. Two lateral notches (12-2, 12-4) and two retention areas (13-2, 13-4) are also present along opposite sides of the device 10. The sizes and forms of the lateral notches (12-2, 12-4) differ from the size and forms of the end notches (12-1, 12-3) for allowing a better retention of the cables. The position of the cables (cable C1 and cable C2) is shown in solid and dotted lines on FIG. 5 for illustrating an example of a way the two cables may be linked and assembled.

FIG. 6 disclose another embodiment of the device 10 in which the form of the plate is different. In this embodiment, device 10 is similar to the device shown in FIG. 5, but has first and second arms extending at a right angle to one another. Device 10 has a first arm including notches (12-1, 12-2) and retention areas (13-1, 13-2) and a second arm including notches (12-3, 12-4) and retention areas (13-3, 13-4).

An exemplary process for using device includes the following:
a first step of connecting the mating connectors;
a second step of fitting the device, comprising the following substeps:
   placing the joined connectors in the center of the device, in such a manner that the bodies of the connector are above the recesses (when needed due to the form of the connector).
   winding the cables around the device and into the slots in the device, working outwards from the center towards the ends. This secures the cables and avoids disconnection through straining the cables.

Although the present disclosure has been described with reference to one or more examples, workers skilled in the art will recognize that changes may be made in form and detail without departing from the scope of the disclosure and/or the appended claims.

1. A cable strain relief device comprising:
a plate comprising at least two lateral notches, said lateral notches providing a gripping area to retain a first cable for connecting to a second cable, and wherein said plate comprises at least one recess located to position a body connector of the first cable when connected to a respective body connector of the second cable.

2. The cable strain relief device of claim 1, wherein the at least two lateral notches are positioned along opposing side edges of the plate.

3. The cable strain relief device of claim 1, wherein said at least two lateral notches are nearly equally distributed on each side of said plate.

4. The cable strain relief device of claim 1, wherein the plate further comprises:
a retention area positioned at an inner end of at least one lateral notch of said at least two lateral notches and laterally offset from a side edge of the plate.

5. The cable strain relief device of claim 4, wherein the at least one lateral notch is generally rectangular and the retention area is semicircular.

6. The cable strain relief device of claim 4, wherein the retention area has an outer retention arm along the side edge of the plate such that the retention area supports the first cable on opposing inside and outside lateral sides of the first cable.

7. The cable strain relief device of claim 1, wherein the at least two lateral notches are inclined at acute angles relative to a side edge of the plate.

8. The cable strain relief device of claim 7, wherein the at least two lateral notches comprise a first set of lateral notches on a first side of the plate and a second set of lateral notches on a second, opposite side of the plate, wherein adjacent lateral notches in the first set have opposite acute angles relative to the first side of the plate, and wherein adjacent lateral notches in the second set have opposite acute angles relative to the second side of the plate.

9. The cable strain relief device of claim 1, wherein the at least two lateral notches comprise a first set of lateral notches on a first side of the plate and a second set of lateral notches on a second, opposite side of the plate, which are longitudinally offset from one another.

10. The cable strain relief device of claim 1, further comprising at least two end notches on opposing ends of the plate.

11. The cable strain relief device of claim 1, wherein said at least one recess comprises a first recess extending into a first side edge of the plate.

12. The cable strain relief device of claim 11, wherein said at least one recess comprises a second recess, the first and second recesses extending into opposing side edges of the plate and being located to position the respective body connectors of the first and second cables when retained by the cable strain relief device.

13. The cable strain relief device of claim 1, wherein said plate comprises an even number of lateral notches, equally distributed on each side of said plate and wherein said notches form an angle of 45° or minus 45° with an orthogonal reference formed by a respective side of said plate.

14. A cable strain relief device comprising:
a plate comprising first and second opposing edges and first and second notches formed in the first and second opposing edges, said notches providing a gripping area to retain a first cable to connect to a second cable, and wherein said plate comprises a first recess extending into the first side edge and located to position a body connector of the first cable when connected to a respective body connector of the second cable.

15. The cable strain relief device of claim 14, wherein the plate comprises:
a retention area positioned at an inner end of at least one of the first and second notches and offset from the respective first or second edge of the plate.

16. The cable strain relief device of claim 15, wherein the first and second notches are generally rectangular and the retention area is semicircular.

17. The cable strain relief device of claim 15, wherein the retention area has an outer retention arm along the respective first or second edge of the plate such that the retention area supports the first cable on opposing inside and outside sides of the first cable.

18. The cable strain relief device of claim 14, wherein plate comprises:
a second recess extending into the second, opposite side edge and being located to position the body connector of the second cable when connected to the first cable and retained by the cable strain relief device.

19. A cable strain relief device comprising:
a plate comprising:
first and second opposing edges;
first and second notches formed in the first and second opposing edges, respectively, said notches providing a gripping area to retain a first cable for connecting to a second cable;
a retention area positioned at an inner end of at least one of the first and second notches and offset from the respective first or second edge of the plate, wherein the first and second notches are generally rectangular and the retention area is semicircular;
a first recess extending into the first side edge and located to position a body connector of the first cable; and
a second recess extending into the second, opposite side edge and being located to position a body connector of the second cable when connected to body connector of the first cable and retained by the cable strain relief device.
